(19) United States
(12) Patent Application Publication
(10) Pub. No.: US 2007/0117527 A1
(43) Pub. Date: May 24, 2007

(54) Method and apparatus of multiple antenna receiver

(76) Inventors: Luzhou Xu, Shanghai (CN); Yan Li, Shanghai (CN); Yanzhong Dai, Shanghai (CN); Jian Liu, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/581,258

(22) PCT Filed: Nov. 12, 2004
(86) PCT No.: PCT/IB04/52400

§ 371 Date: May 30, 2006

(30) Foreign Application Priority Data
Dec. 1, 2003 (CN) 200310118100.6

(51) Int. Cl. H04B 1/04

(52) U.S. Cl. 455/127.4

(57) ABSTRACT

A communication method performed by a mobile terminal with multiple antenna elements, comprising steps of: receiving the corresponding Rx vector signals from multiple antenna elements; calculating the suitable weight vector corresponding to the Rx vector signal of each antenna element according to the corresponding Rx vector signals; and obtaining an output signal with maximum SNR by weighting and then combining said Rx vector signals with said corresponding suitable weight vector respectively. With this method, a desirable system performance can be maintained, and the complexity of generating weight vector can be reduced effectively as well.

### FIELD OF THE INVENTION

The present invention relates generally to a communication method and apparatus, and more particularly, to a communication method and apparatus for use in mobile terminals with multiple antenna elements.

### BACKGROUND ART OF THE INVENTION

In multi-antenna technology, two or more single antenna elements are generally used to construct an antenna array, for adjusting the phase and amplitude of the signals received by each antenna element through weighting them with a suitable weight factor in such a way that the desired signals are strengthened while the interfering signals are suppressed after the received signals are weighted and combined. Compared with traditional single-antenna technology, multi-antenna technology has particular advantage at combating multipath interference, and thus has a promising prospect in various communication fields.

In wireless communication systems, multi-antenna technology can be applied to base stations, for boosting the performance of signal receiving, as well as mobile terminals, for further improving the communication quality. Two technical solutions of applying multi-antenna technology in mobile terminals are described in a patent application entitled “Mobile Terminals with Multiple Antennas and the Method thereof”, filed by KONINKLIJKE PHILIPS ELECTRONICS N.V. on Dec. 27, 2002, Application Serial No. 02160403.7, and another patent application entitled “Mobile Terminals with Smart Antenna and the Method thereof”, filed by the same applicant on the same day, Application Serial No. 02160402.9, and both incorporated herein as reference.

FIG. 1 is a schematic diagram illustrating a mobile terminal with multi-antenna receiving radio signals via the radio propagation channel. As shown in the figure, radio signal d(t) transmitted by transmitter 10 at the BS (base station) is fed to receiver 30 in the UE (user equipment) via radio propagation channel 20 composed of L paths. In the UE, antenna unit 301 composed of N antenna elements, receives the radio signals from said L paths, and inputs the N received radio signals respectively into RF processing unit 302 composed of N groups of RF filters, amplifiers and mixers. In the UE, a stand-alone multi-antenna processing unit 303 is inserted between RF processing unit 302 and MODEM unit 304 of traditional single-antenna mobile terminal. The N radio signals are converted into baseband signals by RF processing unit 302, and then inputted into multi-antenna processing unit 303. In multi-antenna processing unit 303, the methods disclosed in patent application No. 02160403.7 or 02160402.9 can be used to weight and combine the N inputted baseband signals, and input the combined signal into MODEM unit 304 so that information in the baseband signals can be demodulated with methods like Rake receiver, Joint Detection and etc.

As shown in FIG. 1, the RX vector signal r(t) and RX vector noise z(t) received by antenna unit 301 at time t can be respectively expressed in form of matrix as:
r(t)=[r₁(t), r₂(t), . . . , r_{N}(t)]^{T},
z(t)=[z₁(t), z₂(t), . . . , z_{N}(t)]^{T}

where, [.]^{T} denotes matrix transposition in mathematical operation, N is the number of Rx antenna elements, rₙ(t) in the matrix denotes the signal received by the nth antenna element, and zₙ(t) denotes the noise received by the nth antenna element.

It is assumed that the time delay of the signal transmitted to antenna unit 301 via ^{the} Ith path is tₗ and the vector channel response is hₗ, then the Rx vector signal r(t) received by antenna unit 301 can be expressed in equation (1):
r(t)=h₁d(t−t₁)+h₂d(t−t₂)+h₃d(t−t₃)+ . . . +hₗd(t−t_{L})+z(t) (1)

Antenna unit 301 inputs the received Rx vector signal r(t) of the above form into RF processing unit 302. After being converted into baseband signal by RF processing unit 302, the Rx vector signal r(t) is inputted into multi-antenna unit 303. As stated above, multi-antenna processing unit 303 weights and combines Rx vector signal r(t) by using weight vector W=[w₁, w₂, w₃, . . . , w_{N}]^{T}, to generate a combined signal s(t).

The combined signal s(t) can be expressed in equation (2) as follows:

$$\begin{matrix}s ( t ) = {w}_{1}^{*} \cdot {r}_{1} ( t ) + {w}_{2}^{*} \cdot {r}_{2} ( t ) + … + {w}_{N}^{*} \cdot {r}_{N} ( t ) \\ = {\underline{W}}^{H} \cdot \underline{r} ( t ) \\ = {\underline{W}}^{H} \cdot {\underline{h}}_{1} d ( t - {t}_{1} ) + {\underline{W}}^{H} \cdot {\underline{h}}_{2} d ( t - {t}_{2} ) + {\underline{W}}^{H} \cdot \\ {\underline{h}}_{3} d ( t - {t}_{3} ) + … + {\underline{W}}^{H} \cdot {\underline{h}}_{L} d ( t - {t}_{L} ) + {\underline{W}}^{H} \cdot \underline{z} ( t )\end{matrix} \qquad ( 2 )$$

where w₁*, w₂*, . . . , w_{N}* are respectively conjugate complex of w₁, w₂, . . . , w_{N}, and W^{H} is the conjugate transposition of weight vector W.

Multi-antenna processing unit 303 delivers the weighted and combined signal s(t) to MODEM unit 304, then MODEM unit 304 demodulates the weighted and combined signal s(t), to get the information transmitted by the BS.

As described above, in order to correctly demodulate the information transmitted by the BS from signal s(t), multi-antenna unit 303 must choose a suitable weight vector W to weight and combine Rx vector signal r(t) so as to enhance the desired signal and suppress the interfering signal in the combined signal s(t). Two beam forming methods are disclosed, in a PCT patent application entitled “BEAM FORMING METHOD USING WEIGHTING FACTORS THAT ARE PERIODICALLY RENEWED”, with publication No. WO0203565, and another PCT patent application entitled “BEAM FORMING METHOD”, with publication No. WO0191323. In the two methods, weight vector W can be calculated according to the eigenvector and eigenvalue of the autocorrelation matrix of the input signals from multiple antennas, and then the input signals from multiple antennas can be weighted and combined by using the weight vector W.

Good system performance can be achieved when the two methods are utilized to demodulate information from the weighted and combined signal by calculating weight vector W based on the eigenvector and eigenvalue of the autocorrelation matrix of the input signals, but calculation of weight vector W based on the eigenvector and eigenvalue of the autocorrelation matrix of the input signals is very complicated and the hardware complexity for implementing the algorithm also increases accordingly.

### SUMMARY OF THE INVENTION

One object of the present invention is to provide a communication method and apparatus for use in mobile terminals with multiple antenna elements. In the proposed method and apparatus, weight vector W can be generated according to the Maximum SNR (Signal-to-Noise Ratio) criterion, and then the signals received by multiple antenna elements can be weighted and combined by using the weight vector W. The proposed method and apparatus not only could maintain desirable system performance, but also can effectively reduce the complexity of calculating weight vector W.

Another object of the present invention is to provide a communication method and apparatus for use in mobile terminals with multi antenna elements. In the proposed method and apparatus, weight vector W can be generated according to the Recursive Maximum SNR (Signal-to-Noise Ratio) criterion, and weight vector W can be used to weight and combine the signals received by multiple antenna elements. Compared with the method and apparatus based on Maximum SNR, the method and apparatus based on Recursive Maximum SNR can further reduce the complexity of generating weight vector W.

A communication method is proposed, to be executed by a mobile terminal with multiple antenna elements in accordance with the present invention, comprising steps of: (i) receiving the corr esponding RX vector signals from multiple antenna elements; (ii) calculating the suitable weight vector corresponding to the RX vector signal of each antenna element according to the corresponding RX vector signals; (iii) weighting and combining the RX vector signals with the suitable weight vectors respectively, to get an output signal with Maximum SNR.

A mobile terminal with multiple antenna elements is proposed in accordance with the present invention, comprising: (i) a receiving unit, for receiving corresponding RX vector signals from multiple antenna elements; (ii) a calculating unit, for calculating the suitable weight vector corresponding to the RX vector signal of each antenna element according to the corresponding RX vector signal; (iii) a combining unit, for weighting and combining the RX vector signals with the suitable weight vectors respectively, to get an output signal with Maximum SNR.

### BRIEF DESCRIPTION OF THE DRAWINGS

FIG. 1 is a schematic diagram illustrating a mobile terminal with multiple antenna elements receiving radio signals via wireless propagation channel;

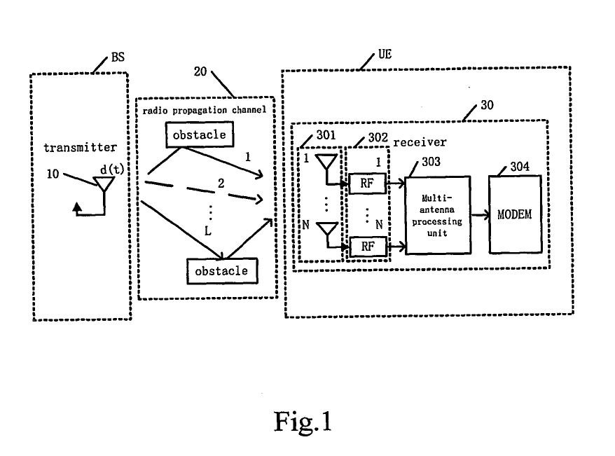

FIG. 2 is a flowchart illustrating the communication method based on Maximum SNR in accordance with the present invention;

FIG. 3 is a block diagram illustrating the communication apparatus based on Maximum SNR in accordance with the present invention;

FIG. 4 is a flowchart illustrating the communication method based on Recursive Maximum SNR in accordance with the present invention;

FIG. 5 is a block diagram illustrating the communication apparatus based on Recursive Maximum SNR in accordance with the present invention.

### DETAILED DESCRIPTION OF THE INVENTION

Assuming the power of the signal d(t) transmitted by the BS is 1, i.e. E{|d(t)|²}=1, E{|d(t)|²} denotes performing expectation operation on signal d(t). According to equation (2) and the Maximum SNR criterion, the cost function F(W) can be expressed as equation (3):

$$\begin{matrix}F ( \underline{W} ) = E \{ \begin{matrix}{\vert {\underline{W}}^{H} \cdot {\underline{h}}_{1} d ( t - {t}_{1} ) \vert}^{2} + {\vert {\underline{W}}^{H} \cdot {\underline{h}}_{2} d ( t - {t}_{2} ) \vert}^{2} + … + \\ {\vert {\underline{W}}^{H} \cdot {\underline{h}}_{L} d ( t - {t}_{L} ) \vert}^{2}\end{matrix} \} / \\ E \{ {\vert {\underline{W}}^{H} \cdot \underline{z} ( t ) \vert}^{2} \} \\ = ( {\underline{W}}^{H} \cdot {R}_{hh} \cdot \underline{W} ) / ( {\underline{W}}^{H} \cdot {R}_{zz} \cdot \underline{W} )\end{matrix} \qquad ( 3 )$$

Where:

[.]^{H} denotes conjugate transposition in mathematical operation;

Rₕₕ is autocorrelation matrix of vector channel response, and
Rₕₕ={h₁·h₁^{H}+h₂·h₂^{H}+ . . . +h_{L}·h_{L}^{H}}/L

wherein hₗ represents vector channel response of the signal arriving at the receiver via the Ith path, and L indicates there are L paths;

R_{zz} is autocorrelation matrix of vector noise, and
R_{zz}=E{z(t)·z(t)^{H}}

In equation (3), if F(W) can reach maximum with a certain weight vector W, it means that the ratio of vector channel response to vector noise in equation (3) also reaches maximum, then the output signal s(t) can also achieve Maximum SNR when the weight vector W is substituted into equation (2). The suitable weight vector W with which F(W) reaches maximum is also called the optimal weight vector Wₒₚₜ.

From mathematical deduction it can be known that, the eigenvector corresponding to the maximum of eigenvector λ in the following equation (4) is the optimal weight vector Wₒₚₜ.
Rₕₕ·W=λ·R_{zz}·W (4)

Thus it can be seen from equation (4) that autocorrelation matrix R_{zz} of vector noise and autocorrelation matrix Rₕₕ of vector channel response are needed first for computing the optimal weight vector Wₒₚₜ.

Herein autocorrelation matrix Rₕₕ of vector channel response can be computed by using existing channel estimation techniques, while autocorrelation matrix R_{zz} of vector noise can be computed according to the autocorrelation matrix Rₕₕ of vector channel response and the autocorrelation matrix Rᵣᵣ of the RX vector signals with equation (5).
R_{zz}=Rᵣᵣ−Rₕₕ (5)

Wherein autocorrelation matrix Rᵣᵣ of the RX vector signals in equation (5) can be computed by performing mathematical expectation operation on RX vector signal r(t).
Rᵣᵣ=E{r(t)·r(t)^{H}} (6)

Based on the above principle, descriptions will be given below respectively to the two proposed communication methods and apparatuses for use in mobile terminals with multiple antenna elements, in conjunction with accompanying drawings.

1. The Method and Apparatus Based on Maximum SNR

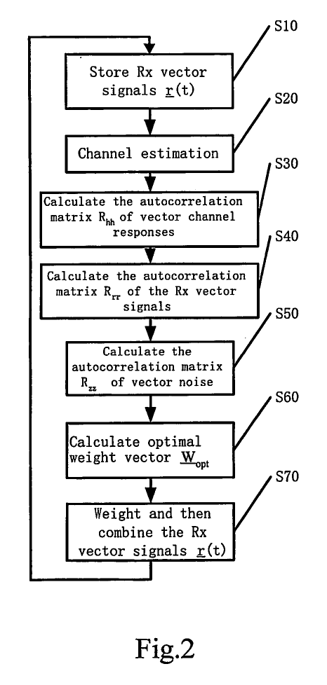

FIG. 2 illustrates the flowchart of the communication method based on Maximum SNR in the present invention. As FIG. 2 shows, the Rx vector signal r(t) received by multiple antenna elements during period T is first cached in the UE's receiver (step S10). Then, the autocorrelation matrix Rₕₕ of vector channel response can be obtained through estimating the channel parameters of the Rx vector signal r(t) (step S20).

In step S20, the vector channel response {h₁, h₂, . . . h_{L}} of the L propagation paths can be estimated according to the Rx vector signal r(t), by using the method disclosed in the patent application entitled “Method for detecting downlink training sequences in TDD/CDMA systems”, filed by KONINKLIJKE PHILIPS ELECTRONICS N.V. on Dec. 30, 2002 in china, Application Serial No. 02160461.4.

After the vector channel response {h₁, h₂, . . . h_{L}} of the L propagation paths is estimated, the autocorrelation matrix Rₕₕ of vector channel response can be obtained by using the above equation Rₕₕ={h₁·h₁^{H}+h₂·h₂^{H}+ . . . +h_{L}·h_{L}^{H}}/L (step S30).

After the autocorrelation matrix Rₕₕ of vector channel response is determined, the autocorrelation matrix Rᵣᵣ of the Rx vector signal still need be decided, to compute the autocorrelation matrix R_{zz} of vector noise by using equation (5). In the present invention, statistical method in time dimension can be adopted to perform expectation operation on all Rx vector signals received by the N antenna elements over period T in the cached Rx vector signals, as shown in equation (7), to get the autocorrelation matrix Rᵣᵣ of the Rx vector signals of the N antenna elements (step S40).
Rᵣᵣ={r(1)·r(1)^{H}+r(2)·r(2)^{H}+ . . . +r(t)·r(t)^{H}+ . . . +r(T)·r(T)^{H}}/T (7)

Then, the autocorrelation matrix R_{zz} of vector noise can be computed according to the calculated autocorrelation matrix Rₕₕ of vector channel response, the autocorrelation matrix Rᵣᵣ of the Rx vector signal and equation (5) (step S50).

Next, the optimal weight vector Wₒₚₜ is computed according to the autocorrelation matrix R_{zz} of vector noise, the autocorrelation matrix Rₕₕ of vector channel response and equation (4), and taken as the optimal weight vector Wₒₚₜ of all Rx signals over period T in the Rx vector signal r(t) cached in the buffer (i.e. all signals received by the N antenna elements over period T) (steps S60).

Last, the received signals at different times in Rx vector signal r(t) are weighted and combined according to the optimal weight vector Wₒₚₜ and equation (2), to get the signal s(t) with the Maximum SNR (step S70).

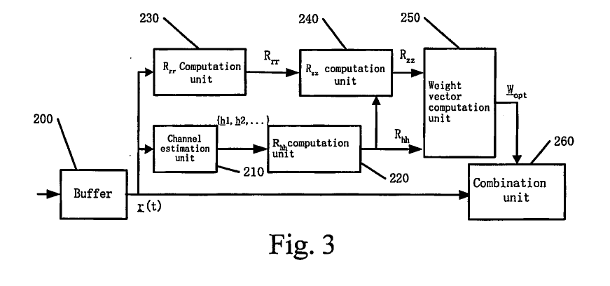

FIG. 3 is a block diagram illustrating the above communication apparatus based on Maximum SNR. As shown in FIG. 3, first, buffer unit 200 caches the Rx vector signal r(t) received by multiple antenna elements over period T. Channel estimation unit 210 estimates the vector channel response {h₁, h₂, . . . h_{L}} of the propagation channels according to the cached Rx vector signal r(t) in buffer unit 200, and outputs the estimation result to Rₕₕ computation unit 220. Rₕₕ computation unit 220 computes the autocorrelation matrix Rₕₕ of vector channel response by taking advantage of Rₕₕ={h₁·h₁^{H}+h₂·h₂^{H}+ . . . +h_{L}·h_{L}^{H}}/L, and inputs the computation result to R_{zz} computation unit 240 and weight vector computation unit 250. Rᵣᵣ computation unit 230 computes the autocorrelation matrix Rᵣᵣ of the Rx vector signal according to the Rx vector signal r(t) cached in buffer unit 200, and outputs the computed Rᵣᵣ to R_{zz} computation unit 240. R_{zz} computation unit 240 computes the autocorrelation matrix R_{zz} of vector noise with equation (5) according to the Rᵣᵣ from Rᵣᵣ computation unit 230 and the Rₕₕ from Rhh computation unit 220, and then outputs the R_{zz} to weight vector computation unit 250. Weight vector computation unit 250 computes the optimal weight vector Wₒₚₜ with equation (4) according to the R_{zz} from R_{zz} computation unit 240 and the Rₕₕ from Rₕₕ computation unit 220, and outputs the optimal weight vector Wₒₚₜ to combination unit 260. After the optimal weight vector Wₒₚₜ is inputted, combination unit 260 receives the Rx vector signal r(t) from buffer unit 200, then weights and combines the signals received by the N antenna elements over period T with the optimal weight vector Wₒₚₜ, to get a signal s(t) with Maximum SNR.

2. Method Based on Recursive Maximum SNR

In the above method based on Maximum SNR, the autocorrelation matrix Rᵣᵣ of the Rx vector signal is computed by using all signals in the Rx vector signal r(t) received by the N antenna elements over period T, and the optimal weight vector Wₒₚₜ is computed by using the autocorrelation matrix Rᵣᵣ of the Rx vector signal.

There may be a large amount of signals contained in the Rx vector signal r(t), so computation of the optimal weight vector Wₒₚₜ by using all signals in the Rx vector signal r(t) will also bring to a large amount of computation, and thus the corresponding hardware will be very complicated too.

To further reduce the hardware complexity, the Recursive Maximum SNR method only uses the signals received over the chosen time range in the Rx vector signal r(t) to compute the autocorrelation matrix Rᵣᵣ of the Rx vector signal corresponding to the chosen time range, and then computes the optimal weight vector Wₒₚₜ corresponding to the chosen time range by using the autocorrelation matrix Rᵣᵣ of the Rx vector signal. Afterwards, the optimal weight vector Wₒₚₜ of the signals received over subsequent time can be determined by using the autocorrelation matrix Rᵣᵣ of the Rx vector signal corresponding to the chosen time range and its optimal weight vector Wₒₚₜ.

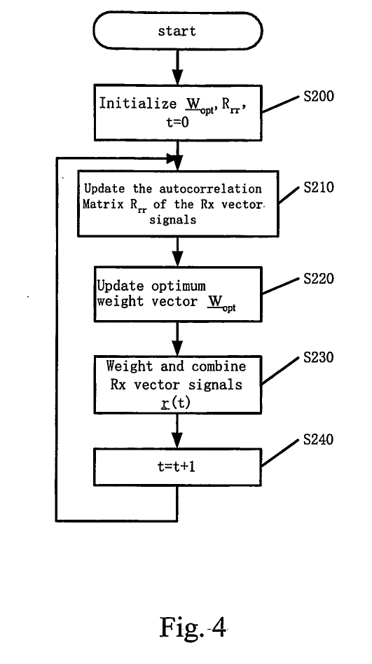

In the following section, a detailed description will be given to the communication method based on Recursive Maximum SNR, in conjunction with the flowchart in FIG. 4.

First, when t=0 (i.e. no radio signal is received), the autocorrelation matrix Rᵣᵣ of the Rx vector signal and the optimal weight vector Wₒₚₜ are initialized. For example, the autocorrelation matrix Rᵣᵣ of the Rx vector signal is initialized to a zero matrix while the optimal weight vector Wₒₚₜ is initialized to [1, 1, . . . , 1]^{T}/sqrt(N), wherein sqrt(N) is root-mean-square operation (step S200).

Then, the update procedure for the autocorrelation matrix Rᵣᵣ of the Rx vector signal is performed (step S210). This step includes: (I) choosing a time range, e.g. a time range to be determined by the beginning time parameter K and ending time parameter M (also called time window), (II) representing the autocorrelation matrix Rᵣᵣ of the Rx vector signal over the chosen time range as equation (9) according to equation (7):

$${R}_{rr} ( t ) = \{ \begin{matrix}\begin{matrix}\begin{matrix}\begin{matrix}\underline{r} ( t - K ) \cdot {\underline{r} ( t - K )}^{H} + \underline{r} ( t - K + 1 ) \cdot \\ {\underline{r} ( t - K + 1 )}^{H} + … + \underline{r} ( t ) \cdot {\underline{r} ( t )}^{H} +\end{matrix} \\ \underline{r} ( t + 1 ) \cdot {\underline{r} ( t + 1 )}^{H} + … +\end{matrix} \\ \underline{r} ( t + M - 1 ) \cdot {\underline{r} ( t M - 1 )}^{H} +\end{matrix} \\ \underline{r} ( t + M ) \cdot {\underline{r} ( t + M )}^{H}\end{matrix} \} / ( K + M + 1 ) \qquad ( 9 )$$

The signals received before and after time t are utilized in equation (9) to compute the autocorrelation matrix Rᵣᵣ of the Rx vector signal of the N antenna elements at time t.

If recursive algorithms are adopted, the autocorrelation matrix Rᵣᵣ(t+1) of the Rx vector signal at time (t+1) can be deduced from equation (9), as shown in equation (10):
Rᵣᵣ(t+1)=Rᵣᵣ(t)+{r(t+1+M)·r(t+1+M)^{H}−r(t−K)·r(t−K)^{H}}/(K+M+1) (10)

That is, according to the autocorrelation matrix Rᵣᵣ(t) of the Rx vector signal at preceding time, the autocorrelation matrix Rᵣᵣ(t+1) of the Rx vector signal at subsequent time can be obtained in a recursive way.

The first time the autocorrelation matrix Rᵣᵣ of the Rx vector signal at subsequent time is computed with equation (10), the autocorrelation matrix Rᵣᵣ(1) of the Rx vector signal at t=1 can be computed with Rᵣᵣ(t) at the preceding time in equation (10) as the initialized autocorrelation matrix Rᵣᵣ of the Rx vector signal. The Rᵣᵣ(t) at t=2 can be updated as Rᵣᵣ(2) by using equation (10) according to Rᵣᵣ(1). In this recursive way, every Rᵣᵣ(t+1) at subsequent time can be updated timely with the Rᵣᵣ(t) at preceding time and equation (10).

After performing the update procedure for the autocorrelation matrix Rᵣᵣ of the Rx vector signal, the update procedure for the optimal weight vector Wₒₚₜ is performed (step S220). The recursive equation for updating Wₒₚₜ is:
W^{H}ₒₚₜ(t+1)=Rᵣᵣ(t+1)·W^{H}ₒₚₜ(t)/(∥Rᵣᵣ(t+1)·W^{H}ₒₚₜ(t)∥) (11)

The first time equation (11) is used to compute the optimal weight vector Wₒₚₜ at subsequent time, the W^{H}ₒₚₜ(t) at the preceding time in equation (11) adopts the initialized W^{H}ₒₚₜ(t), and Rᵣᵣ(t+1) is the updated Rᵣᵣ in above step S210, thus the optimal weight vector Wₒₚₜ(1) at time (t+1) can be computed with equation (11). Similar to the above update procedure for the autocorrelation matrix Rᵣᵣ of the Rx vector signal, every W^{H}ₒₚₜ(t+1) at subsequent time can be updated in the recursive way timely by using the W^{H}ₒₚₜ(t) at preceding time, the updated Rᵣᵣ(t+1) at time (t+1) in step S210 and equation (11).

Last, according to the computed W^{H}ₒₚₜ(t+1) at present time and equation (2), the received signals in the Rx vector signal r(t+1) at current time are weighted and combined, to get the signal s(t+1) with Maximum SNR at present time (step S230).

With the recursive method, after the signals at present time are weighted, then the Rx vector signal r(t) at subsequent time is weighted and combined (step S240), and the procedures from step S210 to S230 is iterated till the received signals at each time in the Rx vector signal r(t) are processed.

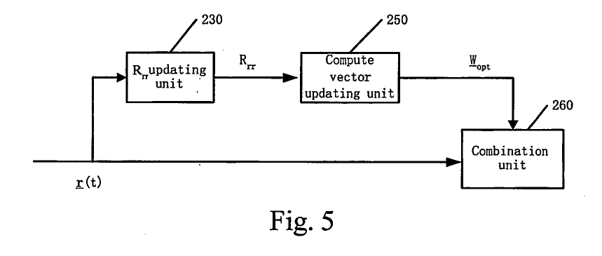

FIG. 5 is a block diagram illustrating the above communication apparatus based on Recursive Maximum SNR method. As FIG. 5 shows, first, Rᵣᵣ updating unit 230 and compute vector updating unit 250 initialize the autocorrelation matrix Rᵣᵣ of the Rx vector signal and optimal weight vector Wₒₚₜ respectively. For example, Rᵣᵣ updating unit 230 initializes the autocorrelation matrix Rᵣᵣ of the Rx vector signal to a zero matrix while compute vector updating unit 250 initializes the optimal weight vector Wₒₚₜ to [1, 1, . . . , 1]^{T}/sqrt(N). Then, Rᵣᵣ updating unit 230 performs the update procedure for the autocorrelation matrix Rᵣᵣ of the Rx vector signal according to the Rx vector signal r(t) from multiple antenna elements, and provides the updated autocorrelation matrix Rᵣᵣ of the Rx vector signal to compute vector updating unit 250. compute vector updating unit 250 performs the update procedure for the optimal weight vector Wₒₚₜ(t), and provides the updated optimal weight vector Wₒₚₜ to combination unit 260. Last, combination unit 260 weights and combines the signals at each time in the Rx vector signal r(t) with equation (2) according to the received optimal weight vector Wₒₚₜ(t) at each time.

### BENEFICIAL RESULTS OF THE INVENTION

As described above, with regard to the communication method and apparatus for use in mobile terminals with multiple antenna elements as proposed in the present invention, the weight vector W is generated according to the Maximum SNR criterion and then the weight vector W is used to weight and combine the signals received by multiple antenna elements. Thus, the proposed communication method and apparatus can maintain desirable system performance, and effectively reduce system complexity as well.

In accordance with another communication method and apparatus for use in mobile terminals with multiple antenna elements as proposed in the present invention, Recursive Maximum SNR method is adopted to generate weight vector W, and the signals received by multiple antenna elements are weighted and combined by using the weight vector W. Thus, the method and apparatus based on Recursive Maximum SNR can lower system complexity further, compared with the method and apparatus based on Maximum SNR.

It is to be understood by those skilled in the art that the multi-antenna receiving method and apparatus as disclosed in the present invention, can be applied to receivers of cellular mobile systems, especially for mobile terminals of TD-SCDMA system, and equally applicable to chipsets and components of multi-antenna systems, and mobile wireless communication terminals and WLAN terminals ant etc.

It is to be understood by those skilled in the art that with regard to the multi-antenna receiving method and apparatus as disclosed in this invention, various modifications can be made without departing from the spirit and scope of the invention as defined by the appended claims.

What is claimed is:

1. A communication method to be performed by a mobile terminal with multiple antenna elements, comprising steps of:
(a) receiving the corresponding Rx vector signals from multiple antenna elements;
(b) calculating the suitable weight vector corresponding to the Rx vector signal of each antenna element according to the corresponding Rx vector signals;
(c) obtaining an output signal with maximum SNR (Signal-to-Noise Ratio) by weighting and then combining the Rx vector signals with the corresponding suitable weight vectors respectively.

2. The method according to claim 1, wherein step (b) includes:
(b1) calculating the autocorrelation matrix of said Rx vector signals with statistical method in time dimension;
(b2) calculating said suitable weight vectors according to the autocorrelation matrix of the Rx vector signals.

3. The method according to claim 2, wherein step (b2) includes:
(b21) calculating the autocorrelation matrix of the vector channel responses according to said Rx vector signals;
(b22) calculating the autocorrelation matrix of the vector noise according to the autocorrelation matrix of the vector channel responses and the autocorrelation matrix of said Rx vector signals;
(b23) calculating the suitable weight vector corresponding to the signal at the chosen time in said Rx vector signals, according to the autocorrelation matrix of the vector channel responses and the autocorrelation matrix of the vector noise.

4. The method according to claim 3, wherein said signal at the chosen time in said Rx vector signals is the signal at each time in said Rx vector signals.

5. The method according to claim 4, wherein step (b23) calculates said suitable weight vector Wₒₚₜ according to the flowing formula:
Rₕₕ·W=λ·R_{zz}·W
Where:
Rhh is the autocorrelation matrix of said vector channel responses;
Rzz is the autocorrelation matrix of said vector noise;
λ is the eigenvalue;
W is the weight vector;
Wherein the weight vector W corresponding to the maximum value of λ is said suitable weight vector Wₒₚₜ.

6. The method according to claim 2, wherein, said statistical method in time dimension is performed on the Rx vector signals over the chosen time range in said Rx vector signals so as to get the autocorrelation matrix corresponding to the Rx vector signals over the chosen time range in said Rx vector signals, wherein said determined suitable weight vector is the suitable weight vector corresponding to the Rx vector signals over the chosen time range in said Rx vector signals, the method further comprising steps of:
(b3) calculating the autocorrelation matrix of subsequent Rx vector signals according to the autocorrelation matrix of said Rx vector signals over the chosen time range;
(b4) determining the suitable weight vector of the subsequent Rx vector signals according to the suitable weight vector of said Rx vector signals over the chosen time range and the autocorrelation matrix of the subsequent Rx vector signals;

7. The method according to claim 6, wherein step (b4) calculates the suitable weight vector of said subsequent Rx vector signals according to the following formula:
W^{H}ₒₚₜ(t+1)=Rᵣᵣ(t+1)·W^{H}ₒₚₜ(t)/(∥Rᵣᵣ(t+1)·W^{H}ₒₚₜ(t)∥)
Where:
Rᵣᵣ(t+1) is the autocorrelation matrix of said subsequent Rx vector signals;
W^{H}ₒₚₜ(t) is the conjugate transposition of the suitable weight vector of said Rx vector signals over said chosen time range;
W^{H}ₒₚₜ(t+1) is the conjugate transposition of the suitable weight vector of said subsequent Rx vector signals;
∥Rᵣᵣ(t+1)·W^{H}ₒₚₜ(t)∥ means performing normal number operation on Rᵣᵣ(t+1)·W^{H}ₒₚₜ(t).

8. A mobile terminal with multiple elements, comprising:
a receiving unit, for receiving the corresponding Rx vector signals from multiple antenna elements;
a calculating unit, for calculating the suitable weight vector corresponding to the Rx vector signal of each element according to the corresponding Rx vector signals; and
a combining unit, for weighting and then combining the Rx vector signals with the corresponding suitable weight vectors respectively, to obtain an output signal with maximum SNR.

9. The mobile terminal according to claim 8, wherein said calculating unit calculates the autocorrelation matrix of said Rx vector signals with statistical method in time dimension, and calculates said suitable weight vector according to the autocorrelation matrix of said Rx vector signals.

10. The mobile terminal according to claim 9, wherein said calculating unit calculates the autocorrelation matrix of the vector channel responses according to said Rx vector signals; calculates the autocorrelation matrix of the vector noise according to the autocorrelation matrix of the vector channel responses and the autocorrelation matrix of said Rx vector signals; and calculates the suitable weight vector corresponding to the signal at the chosen time in said Rx vector signals according to the autocorrelation matrix of the vector channel responses and the autocorrelation matrix of the vector noise.

11. The mobile terminal according to claim 10, wherein the signal at the chosen time in said Rx vector signals is the signal at each time in said Rx vector signals.

12. The mobile terminal according to claim 11, wherein said calculating unit calculates said suitable weight vector Wₒₚₜ according to the following formula:
Rₕₕ·W=λ·R_{zz}·W
Where:
Rₕₕ is the autocorrelation matrix of said vector channel responses;
R_{zz} is the autocorrelation matrix of said vector noise;
λ is the eigenvalue;
W is the weight vector;
Wherein the weight vector W corresponding to the maximum value of λ is said suitable weight vector Wₒₚₜ.

13. The mobile terminal according to claim 9, wherein said statistical method in time dimension is performed on the Rx vector signals over the chosen time range in said Rx vector signals so as to get the autocorrelation matrix corresponding to the Rx vector signals over the chosen time range in said Rx vector signals, wherein said determined suitable weight vector is the suitable weight vector corresponding to said Rx vector signals over the chosen time range, said calculating unit calculates the autocorrelation matrix of subsequent Rx vector signals according to the autocorrelation matrix of the Rx vector signals over the chosen time range, and determines the suitable weight vector of the subsequent Rx vector signals according to the suitable weight vector of the Rx vector signals over the chosen time range and the autocorrelation matrix of the subsequent Rx vector signals.

14. The mobile terminal according to claim 13, wherein said calculating unit calculates the suitable weight vector of said subsequent Rx vector signals according to the following formula:
W^{H}ₒₚₜ(t+1)=Rᵣᵣ(t+1)·W^{H}ₒₚₜ(t)/(∥Rᵣᵣ(t+1)·W^{H}ₒₚₜ(t)∥)
Where:
Rᵣᵣ(t+1) is the autocorrelation matrix of said subsequent Rx vector signals;
W^{H}ₒₚₜ(t) is the conjugate transposition of the suitable weight vector of said Rx vector signals over the chosen range time;
W^{H}ₒₚₜ(t+1) is the conjugate transposition of the suitable weight vector of said subsequent Rx vector signals;
∥Rᵣᵣ(t+1)·W^{H}ₒₚₜ(t)∥ means performing normal number operation on Rᵣᵣ(t+1)·W^{H}ₒₚₜ(t).
